(19) United States
(12) Patent Application Publication
(10) Pub. No.: US 2026/0072660 A1
(43) Pub. Date: Mar. 12, 2026

(54) SIMPLIFYING CONDITIONAL STRUCTURES FOR LOOP OPTIMIZATION

(71) Applicant: International Business Machines Corporation, Armonk, NY (US)

(72) Inventors: Alexandru Gatea, Toronto (CA); Bardia Mahjour, Newmarket (CA); Prasanth Chatarasi, White Plains, NY (US)

(21) Appl. No.: 18/826,280

(22) Filed: Sep. 6, 2024

(51) Int. Cl. G06F 8/41

(52) U.S. Cl. CPC G06F 8/4441

(57) ABSTRACT

A computer implemented method for generating modified loops for loops with a number of conditionals is provided. A processor set generates a conditional tree based on the number of conditionals in the loops. A value is determined by evaluating each conditional in the number of conditionals The processor set generates a multi-dimensional table based on values from the number of conditionals. The processor set determines an induction variable for the modified loops. The processor set slices the multi-dimensional table to generate a number of slices. The processor set generates a number of sequences by splitting values in each slice. The processor set generates a number of new conditionals based on the determined induction variable and at least values and strides in the number of sequences. The processor set generates the modified loops based on the number of new conditionals.

### BACKGROUND

The disclosure relates generally to an improved computer system and more specifically to loop modification of program instructions.

Loop optimization is used in computer programming to increase the performance of loops in program instructions. Loops are repetitive blocks of program instructions that include a number of conditionals and can be used to operate on data for some number of times. These operations can include performing calculations, transformations, or other operations on data.

Loop splitting is a technique used in optimizing the performance of loops in program instructions. This method involves breaking a single loop into multiple loops such that each of the multiple loops handles a portion of the original loop's workload. In this case, loop splitting can enhance parallelism, reduce branch mispredictions, and improve cache utilization. By splitting loops, the computer system can take advantage of modern processors' ability to execute multiple program instructions simultaneously to reduce execution times.

Full loop unrolling is another loop optimization technique that replicates body of a loop multiple times to eliminate the control overhead. Instead of iterating through the loop, the loop's iterations are manually expanded to replace the loop with a sequence of repeated program instructions. Full loop unrolling improves the performance of a program instruction by reducing the number of branch instructions and loop control logic.

As depicted, these types of loop optimization techniques can obtain increased performance for many conventional workloads. However, these different types of loop optimizations may not provide the desired optimization of loops in program instructions in all situations.

### SUMMARY

According to an illustrative embodiment, a computer implemented method for generating modified loops for loops with a number of conditionals is provided. A processor set generates a conditional tree based on the number of conditionals in the loops. A value is determined by evaluating each conditional in the number of conditionals The processor set generates a multi-dimensional table based on values from the number of conditionals. The processor set determines an induction variable for the modified loops. The processor set slices the multi-dimensional table to generate a number of slices. The processor set generates a number of sequences by splitting values in each slice. The processor set generates a number of new conditionals based on the determined induction variable and at least values and strides in the number of sequences. The processor set generates the modified loops based on the number of new conditionals. According to other illustrative embodiments, a computer system and a computer program product for generating modified loops for loops with a number of conditionals is provided.

### BRIEF DESCRIPTION OF THE DRAWINGS

FIG. 1 is a block diagram of a computing environment in accordance with an illustrative embodiment;

FIG. 2 depicts a block diagram of a program instructions management environment in accordance with an illustrative embodiment;

FIG. 3A-3B depicts a diagram illustrating generation of modified loops for loops with a number of conditionals in accordance with an illustrative embodiment;

FIG. 4A-4C depicts a diagram illustrating generation of modified loops for loops with a number of conditionals in accordance with an illustrative embodiment;

FIG. 5 depicts a flowchart for illustrating a process for generating modified loops for loops with a number of conditionals in accordance with an illustrative embodiment;

FIG. 6 depicts a flowchart for illustrating a process for generating sequences by splitting values in each slice in accordance with an illustrative embodiment;

FIG. 7 depicts a flowchart for illustrating a process for adjusting sequences in accordance with an illustrative embodiment;

FIG. 8 depicts a flowchart for illustrating a process for adjusting sequences in accordance with an illustrative embodiment;

FIG. 9 depicts a flowchart for illustrating a process for determining the induction variable in accordance with an illustrative embodiment;

FIG. 10 depicts a flowchart for illustrating a process for generating the number of new conditionals in accordance with an illustrative embodiment;

FIG. 11 depicts a flowchart for illustrating a process for generating modified loops for loops with a number of conditionals in accordance with an illustrative embodiment;

FIG. 12 depicts a flowchart for illustrating a process for generating new conditionals for the modified loop in accordance with an illustrative embodiment;

FIG. 13 depicts a flowchart for illustrating a process for replacing loops with modified loops of the lowest cost in accordance with an illustrative embodiment;

FIG. 14 depicts a flowchart for illustrating a process for performing cost analysis in accordance with an illustrative embodiment;

FIG. 15 is a block diagram of a data processing system in accordance with an illustrative embodiment.

### DETAILED DESCRIPTION

A computer implemented method generates modified loops for loops with a number of conditionals. A processor set generates a conditional tree based on the number of conditionals in the loops. The processor set generates a multi-dimensional table based on values for the number of conditionals obtained from the conditional tree. A value is determined by evaluating each conditional in the number of conditionals. The processor set determines an induction variable for the modified loops. The processor set slices the multi-dimensional table to generate a number of slices. Each slice in the number of slices represents at least a portion of the multi-dimensional table. The processor set generates a number of sequences by splitting values in each slice. Values and strides in the number of sequences are determined for proper execution of the modified loops. The processor set generates a number of new conditionals based on the determined induction variable and at least values and strides in the number of sequences. The processor set generates the modified loops based on the number of new conditionals. As a result, the illustrative embodiments provide a technical effect of modifying loops to reduce code size and control overhead.

In the illustrative embodiments, each slice from the number of slices comprises a set of values obtained by varying the determined induction variable while fixing other existing induction variables in the loops with the number of conditionals. As a result, the illustrative embodiments provide a technical effect of identifying linear patterns for values in the number of sequences for each slice.

In the illustrative embodiments, as part of generating the number of sequences by splitting values in each slice, the processor set generates sequences with fixed stride by splitting values in each slice. Each sequence in the sequences with fixed stride corresponds to a number of values for a result index in each slice. As a result, the illustrative embodiments provide a technical effect of having sequences with similar structures for efficiently generating modified loops that are more compact.

In the illustrative embodiments, the processor set further determines whether the induction variable is the innermost iterator for the loops with the number of conditionals based on the conditional tree. The processor set adjusts sequences with nonzero stride in the sequences with fixed stride to generate the number of sequences in response to determining that the determined induction variable is not the innermost iterator for the loops with a number of conditionals based on the conditional tree. The value for the strides of each sequence in the number of sequences is zero. As a result, the illustrative embodiments provide a technical effect of eliminating the definition-before-use issues in the modified loops to ensure proper execution of the modified loops.

In the illustrative embodiments, the processor set further generates the number of sequences by splitting sequences with nonzero stride in the sequences with fixed stride. Number of sequences for each result index is same across different slices. As a result, the illustrative embodiments provide a technical effect of aligning values in the number of slices for ensuring proper execution of the modified loops generated based on the number of sequences.

In the illustrative embodiments, as part of determining the induction variable for the modified loops, the processor set generates the induction variable to mimic traversing of the multi-dimensional table in a one-dimensional fashion. As a result, the illustrative embodiments provide a technical effect of providing an alternative slicing method that treats the entire multi-dimensional table as one single slice.

In the illustrative embodiments, as part of generating the number of new conditionals based on the determined induction variable and at least values and strides in the number of sequences, the processor set generates a number of lists for each slice in the number of slices based on uncommon values and strides in the number of sequences and values of the determined induction variable corresponding to last terms for sequences of each slice. The processor set generates a number of new induction variables for the modified loops. The start values and strides for the number of new induction variables are determined based on values from the number of lists. The processor set generates the number of new conditionals using the number of new induction variables, existing variables from the loops, values from the number of lists, and common values in the number of sequences. As a result, the illustrative embodiments provide a technical effect of generating new conditionals that can be used for the modified loops to reduce code size and control overhead.

A computer system comprises a processor set, a set of one or more computer-readable storage media, and program instructions stored in the set of one or more storage media to cause the processor set to perform the following operations. The processor set generates a conditional tree based on a number of conditionals in loops. A value is determined by evaluating each conditional in the number of conditionals The processor set generates a multi-dimensional table based on values for the number of conditionals obtained from the conditional tree. The processor set determines an induction variable for modified loops for the loops. The processor set slices the multi-dimensional table to generate a number of slices. Each slice in the number of slices represents at least a portion of the multi-dimensional table. The processor set generates a number of sequences by splitting values in each slice. Values and strides in the number of sequences are determined for proper execution of the modified loops. The processor set generates a number of new conditionals based on the determined induction variable and at least values and strides in the number of sequences. The processor set generates the modified loops based on the number of new conditionals. As a result, the illustrative embodiments provide a technical effect of modifying loops to reduce code size and control overhead.

In the illustrative embodiments, each slice from the number of slices comprises a set of values obtained by varying the determined induction variable while fixing other existing induction variables in the loops with the number of conditionals. As a result, the illustrative embodiments provide a technical effect of identifying linear patterns for values in the number of sequences for each slice.

In the illustrative embodiments, as part of generating the number of sequences by splitting values in each slice, the processor set further executes the program instructions to generate sequences with fixed stride by splitting values in each slice. The sequence in the sequences with fixed stride corresponds to a number of values for a result index in each slice. As a result, the illustrative embodiments provide a technical effect of having sequences with similar structures for efficiently generating modified loops that are more compact.

In the illustrative embodiments, the processor set further executes the program instructions to determine whether the determined induction variable is the innermost iterator for the loops with the number of conditionals based on the conditional tree. The processor set further executes the program instructions to adjust sequences with nonzero stride in the sequences with fixed stride to generate the number of sequences in response to determining that the induction variable is not the innermost iterator for the loop with a number of conditionals based on the conditional tree. The value for the strides of each sequence in the number of sequences is zero. As a result, the illustrative embodiments provide a technical effect of eliminating the definition-before-use issues in the modified loops to ensure proper execution of the modified loops.

In the illustrative embodiments, the processor set further executes the program instructions to generate the number of sequences by splitting sequences with nonzero stride in the sequences with fixed stride. The number of sequences for each result index is same across different slices. As a result, the illustrative embodiments provide a technical effect of aligning values in the number of slices for ensuring proper execution of the modified loops generated based on the number of sequences.

In the illustrative embodiments, as part of determining the induction variable for the modified loops, the processor set further executes the program instructions to generate the induction variable to mimic traversing of the multi-dimensional table in a one-dimensional fashion. As a result, the illustrative embodiments provide a technical effect of providing an alternative slicing method that treats the entire multi-dimensional table as one single slice.

In the illustrative embodiments, as part of generating the number of new conditionals based on the determined induction variable and at least values and strides in the number of sequences, the processor set further executes the program instructions to generate a number of lists for each slice in the number of slices based on uncommon values and strides in the number of sequences, and values of the determined induction variable corresponding to last terms for sequences of each slice. The processor set further executes the program instructions to generate a number of new induction variables for the modified loops. The start values and strides for the number of new induction variables are determined based on values from the number of lists. The processor set further executes the program instructions to generate the number of new conditionals using the number of new induction variables, existing variables from the loops, values from the number of lists, and common values in the number of sequences. As a result, the illustrative embodiments provide a technical effect of generating new conditionals that can be used for the modified loops to reduce code size and control overhead.

In the illustrative embodiments, a computer program product for generating modified loops for loops with a number of conditionals is provided. The computer program product comprises a set of one or more computer-readable storage media and program instructions, stored in the set of one or more storage media to perform the following computer operations. The program instructions are executable by a computer system to generate a conditional tree based on the number of conditionals in the loops. A value is determined by evaluating each conditional in the number of conditionals. The program instructions are executable by a computer system to cause the computer system to generate a multi-dimensional table based on values for the number of conditionals obtained from the conditional tree. The program instructions are executable by a computer system to cause the computer system to slice the multi-dimensional table to generate a number of slices. Each slice in the number of slices represents at least a portion of the multi-dimensional table. The program instructions are executable by a computer system to cause the computer system to generate a number of sequences by splitting values in each slice. Values and strides in the number of sequences are determined for proper execution of the modified loops. The program instructions are executable by a computer system to cause the computer system to generate a number of new conditionals based on the determined induction variable and at least values and strides in the number of sequences. The program instructions are executable by a computer system to cause the computer system to generate the modified loops based on the number of new conditionals. As a result, the illustrative embodiments provide a technical effect of modifying loops to reduce code size and control overhead.

In the illustrative embodiments, each slice from the number of slices comprises a set of values obtained by varying the determined induction variable while fixing other existing induction variables in the loops with the number of conditionals. As a result, the illustrative embodiments provide a technical effect of identifying linear patterns for values in the number of sequences for each slice.

In the illustrative embodiments, as part of generating the number of sequences by splitting values in each slice, the program instructions are further executable by the computer system to cause the computer system to generate sequences with fixed stride by splitting values in each slice. Each sequence in the sequences with fixed stride corresponds to a number of values for a result index in each slice. As a result, the illustrative embodiments provide a technical effect of having sequences with similar structures for efficiently generating modified loops that are more compact.

In the illustrative embodiments, the program instructions are further executable by the computer system to cause the computer system to determine whether the determined induction variable is the innermost iterator for the loops with the number of conditionals based on the conditional tree. The program instructions are further executable by the computer system to cause the computer system to adjust sequences with nonzero stride in the sequences with fixed stride to generate the number of sequences in response to determining that the induction variable is not the innermost iterator for the loop with the number of conditionals based on the conditional tree. The value for the strides of each sequence in the number of sequences is zero. As a result, the illustrative embodiments provide a technical effect of eliminating the definition-before-use issues in the modified loops to ensure proper execution of the modified loops.

In the illustrative embodiments, the program instructions are further executable by the computer system to cause the computer system to generate the number of sequences by splitting sequences with nonzero stride in the sequences with fixed stride. The number of sequences for each result index is the same across different slices. As a result, the illustrative embodiments provide a technical effect of aligning values in the number of slices for ensuring proper execution of the modified loops generated based on the number of sequences.

In the illustrative embodiments, as part of generating the number of new conditionals based on the determined induction variable and at least values and strides in the number of sequences, the program instructions are further executable by the computer system to cause the computer system to generate a number of lists for each slice in the number of slices based on uncommon values and strides in the number of sequences, and values of the determined induction variable corresponding to last terms for sequences of each slice. The program instructions are further executable by the computer system to cause the computer system to generate a number of new induction variables for the modified loops. The start values and strides for the number of new induction variables are determined based on values from the number of lists. The program instructions are further executable by the computer system to cause the computer system to generate the number of new conditionals using the number of new induction variables, existing variables from the loops, values from the number of lists, and common values in the number of sequences. As a result, the illustrative embodiments provide a technical effect of generating new conditionals that can be used for the modified loops to reduce code size and control overhead.

A computer implemented method generates modified loops for loops with a number of conditionals. A processor set generates a tree based on the number of conditionals in the loops. The processor set generates a multi-dimensional table based on values from the number of conditionals. The processor set slices the multi-dimensional table to generate a number of slices using a number of slicing methods. Each slice in the number of slices represents at least a portion of the multi-dimensional table. The processor set generates a number of sequences by splitting values in each slice for each slicing method. The processor set generates a number of new conditionals based on the determined induction variable and at least values and strides in the number of sequences for each slicing method. The processor set generates the modified loops based on the number of new conditionals for each slicing method. As a result, the illustrative embodiments provide a technical effect of modifying loops using different methods to reduce code size and control overhead.

In the illustrative embodiments, as part of generating, by the processor set, the number of new conditionals based on at least values and strides in the number of sequences for each slicing method, the processor set further generates a number of lists for each slicing method based on uncommon values in the number of sequences for each slicing method. The processor set further generates a number of new induction variables for the modified loops of each slicing method. The start values and strides for the number of new induction variables are determined based on values from the number of lists for each slicing method. The processor set further generates the number of new conditionals for each slicing method using the number of new induction variables for the modified loops of each slicing method, existing variables from the loops, values from the number of lists, and common values in the number of sequences for each slicing method. As a result, the illustrative embodiments provide a technical effect of modifying loops using different methods to reduce code size and control overhead.

In the illustrative embodiments, the processor set further generates a conditional tree for the modified loops for each slicing method. The processor set further performs a cost analysis for the modified loops for each slicing method based on the conditional tree for the modified loops for each slicing method and the number of new induction variables for the modified loops of each slicing method. The processor set further replaces the loops with the number of conditionals using modified loops of a slicing method with lowest cost. As a result, the illustrative embodiments provide a technical effect of modifying loops with a method with lowest cost to reduce code size and control overhead.

In the illustrative embodiments, as part of performing, by the processor set, the cost analysis for the modified loops for each slicing method based on the conditional tree for the modified loops for each slicing method and the number of new variables for the modified loops of each slicing method, the processor set further identifies a set of modified loops with lowest number of leaves in the conditional trees. The processor set further determines whether the set of modified loops comprise loops for more than one slicing method. The processor set further identifies the set of modified loops as the modified loops of the slicing method with lowest cost. As a result, the illustrative embodiments provide a technical effect of selecting the modified loops generated by a slicing method with the lowest cost.

In the illustrative embodiments, the processor set further identifies a subset of modified loops with lowest number of new induction variables for a slicing method from the set of modified loops as the modified loops of the slicing method with lowest cost, in response to determining that the set of modified loops does comprise more than one slicing method. As a result, the illustrative embodiments provide a technical effect of selecting the modified loops generated by a slicing method with the lowest cost in situation of a tie.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one or more storage media (also called “mediums”) collectively included in a set of one or more storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

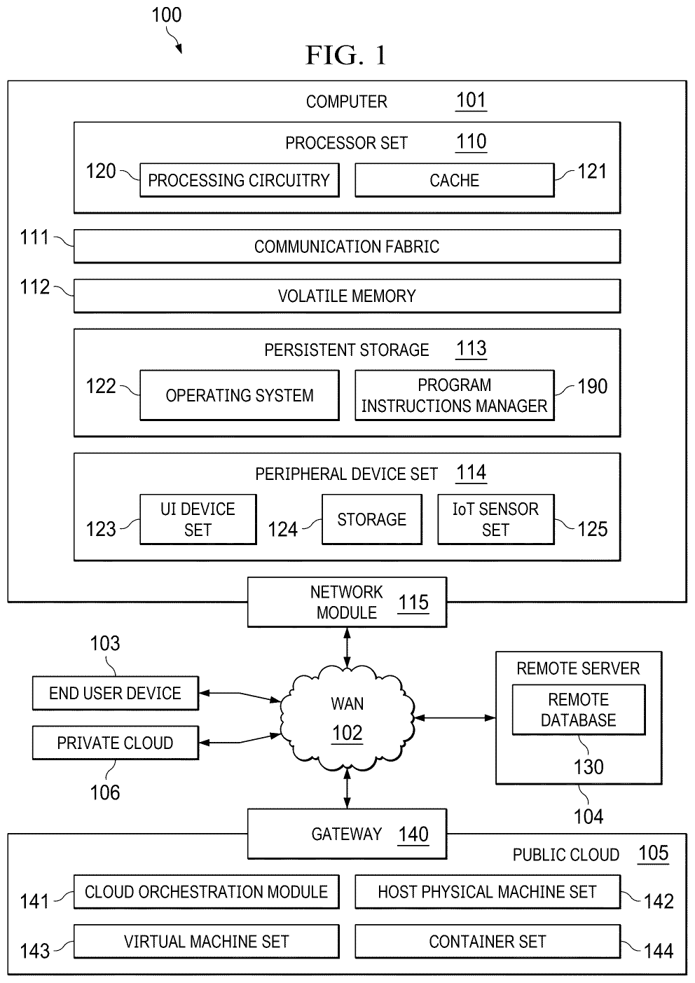

With reference now to the figures, and in particular with reference to FIG. 1, a block diagram of a computing environment is depicted in accordance with an illustrative embodiment. Computing environment 100 contains an example of an environment for the execution of at least some of the computer code involved in performing the inventive methods, such as program instructions manager 190. In addition to program instructions manager 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and program instructions manager 190, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one or more computer processors of any type now known or to be developed in the future. Processing circuitry 120 may be distributed over multiple packages, for example, multiple coordinated integrated circuit chips.

Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry.

Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions and associated data are accessed by processor set 110 to control and direct performance of the inventive methods. In computing environment 100, at least some of the instructions for performing the inventive methods may be stored in program instructions manager 190 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, volatile memory 112 is located in a single package and is internal to computer 101, but, alternatively or additionally, volatile memory 112 may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid state storage devices.

Operating system 122 may take several forms, such as various known proprietary operating systems or open source Portable Operating System Interface-type operating systems that employ a kernel. The code included in program instructions manager 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as a thin client, heavy client, mainframe computer, desktop computer, and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data application portability between the multiple constituent clouds. In this embodiment, public cloud 105 and private cloud 106 are both part of a larger hybrid cloud.

CLOUD COMPUTING SERVICES AND/OR MICROSERVICES: Public cloud 105 and private cloud 106 are programmed and configured to deliver cloud computing services and/or microservices (not separately shown in FIG. 1). Unless otherwise indicated, the word “microservices” shall be interpreted as inclusive of larger “services” regardless of size. Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to an “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The illustrative embodiments recognize and take into account one or more different considerations as described herein. For example, the illustrative embodiments recognize and take into account that conditional structures are used to represent dynamic starting address of tensors for a transfer operation and loop count of inner-loops. The illustrative embodiments recognize and take into account that unoptimized conditional structures are translated into compare and jump instructions that can result in increased execution cycle and program size.

The illustrative embodiments also recognize and take into account that current loop optimization techniques such as loop splitting and full loop unrolling can increase the program size and therefore cannot be applied all the time because of the instruction buffer (IBUFF) constraints. In this illustrative example, instruction buffer constraints refer to the size limitation for the queued instructions in the buffer. In other words, applying transformations such as loop splitting and full loop unrolling can lead to a number of program instructions that exceeds the size limitation for the instruction buffer.

In addition, the illustrative embodiments also recognize and take into account that optimizing loops by reducing the size of program instructions can bring more opportunities for other loop optimization techniques such as loop splitting and full loop unrolling.

Thus, illustrative embodiments of the present invention provide a computer implemented method, computer system, and computer program product for generating modified loops for loops with a number of conditionals to increase computer performance. A processor set generates a conditional tree based on the number of conditionals in the loops. The processor set generates a multi-dimensional table based on values from the number of conditionals. The processor set determines an induction variable for the modified loops. The processor set slices the multi-dimensional table to generate a number of slices. The processor set generates a number of sequences by splitting values in each slice. The processor set generates a number of new conditionals based on the determined induction variable and at least values and strides in the number of sequences. The processor set generates the modified loops based on the number of new conditionals.

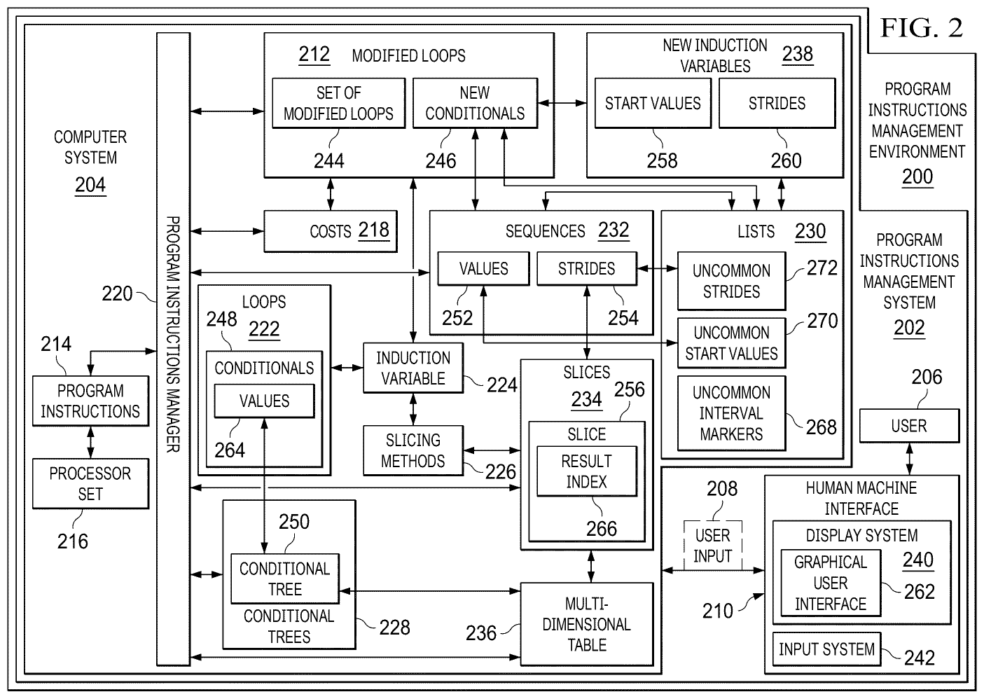

With reference now to FIG. 2, an illustration of a block diagram of a program instructions management environment is depicted in accordance with an illustrative embodiment. In this illustrative example, program instructions management environment 200 includes components that can be implemented in hardware such as the hardware shown in computing environment 100 in FIG. 1.

In this illustrative example, program instructions management system 202 in program instructions management environment 200 generates modified loops 212 for loops 222 in computer system 204 to increase the computer performance for computer system 204. In this illustrative example, program instructions management system 202 includes computer system 204 which includes program instructions manager 220.

Program instructions manager 220 is located in computer system 204. Program instructions manager 220 may be implemented using program instructions manager 190 in FIG. 1.

Program instructions manager 220 can be implemented in software, hardware, firmware, or a combination thereof. When software is used, the operations performed by program instructions manager 220 can be implemented in program instructions configured to run on hardware, such as a processor unit. When firmware is used, the operations performed by program instructions manager 220 can be implemented in program instructions and data and stored in persistent memory to run on a processor unit. When hardware is employed, the hardware can include circuits that operate to perform the operations in program instructions manager 220.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As used herein, “a number of” when used with reference to items, means one or more items. For example, “a number of operations” is one or more operations.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C,” may include item A, item A and item B, or item B. This example also may include item A, item B, and item C, or item B and item C. Of course, any combination of these items can be present. In some illustrative examples, “at least one of” can be, for example, without limitation, two of item A; one of item B; and ten of item C; four of item B and seven of item C; or other suitable combinations.

As used herein, “medium access control (MAC) address” refers to a unique identifier assigned to a network interface controller of a device for communication within a network. In this illustrative example, “medium access control (MAC) address” can also be referred to as “media access control (MAC) address”.

Computer system 204 is a physical hardware system and includes one or more data processing systems. When more than one data processing system is present in computer system 204, those data processing systems are in communication with each other using a communications medium. The communications medium can be a network. The data processing systems can be selected from at least one of a computer, a server computer, a tablet computer, or some other suitable data processing system.

As depicted, computer system 204 includes processor set 216 that is capable of executing program instructions 214 implementing processes in the illustrative examples. In other words, program instructions 214 are computer-readable program instructions.

As used herein, a processor unit in processor set 216 is a hardware device and is comprised of hardware circuits such as those on an integrated circuit that respond to and process instructions and program code that operate a computer. A processor unit can be implemented using processor set 110 in FIG. 1. When processor set 216 executes program instructions 214 for a process, processor set 216 can be one or more processor units that are in the same computer or in different computers. In other words, the process can be distributed between processor set 216 on the same or different computers in computer system 204.

Further, processor set 216 can be of the same type or different types of processor units. For example, processor set 216 can be selected from at least one of a single core processor, a dual-core processor, a multi-processor core, a general-purpose central processing unit (CPU), a graphics processing unit (GPU), a digital signal processor (DSP), or some other type of processor unit.

As depicted, computer system 204 includes loops 222. Loops 222 are portions of program instructions that are control structures for allowing a sequence of program instructions to be executed repeatedly. In this illustrative example, loops 222 can be a portion of program instructions 214 or a portion of different program instructions in computer system 204.

In this illustrative example, loops 222 includes a number of conditionals 248. The number of conditionals 248 are decision making statements within body of loops 222. The number of conditionals 248 allows execution of different blocks of program instructions depending on certain conditions. For example, the number of conditionals can be “if” statement, “else” and “else if” statement, “switch statement”, or any suitable conditional statements.

In this illustrative example, the number of conditionals 248 in loops 222 can be used by program instructions manager 220 to generate a conditional tree. For example, conditional tree 250 in conditional trees 228 can be generated based on values 264 for conditionals 248 in loops 222. In this illustrative example, each value in values 264 is determined by evaluating a conditional in conditionals 248. In this illustrative example, conditional trees 228 are a representation of the decision making structure that governs flow of execution within loops 222 based on the number of conditionals 248. In this illustrative example, each conditional tree in conditional trees 228 includes condition nodes that represent conditional tests within loop 222 and loop node represent the body of loop where operations to be performed are defined. In addition, conditional trees 228 can also include branches that represent the flow of execution based on results of condition nodes and leaves that represent end results of conditionals. In this illustrative example, values 264 are represented by leaves in conditional tree 250.

Program instructions manager 220 can generate multi-dimensional table 236 based on conditional tree 250 and values 264. In this illustrative example, multi-dimensional table 236 is generated by populating values yielded by conditionals through iterations from conditional tree 250. Each dimension in multi-dimensional table 236 represents an iterator in loops 222. In this illustrative example, iterators are objects in loops 222 that traverse through iterations of loops one at a time.

In this illustrative example, program instructions manager 220 slices multi-dimensional table 236 to generate a number of slices 234. Each slice in the number of slices 234 represents a portion of multi-dimensional table 236 and includes a set of values from the portion of multi-dimensional table 236. For example, the number of slices 234 includes slice 256 that represents a portion of multi-dimensional table 236. In this example, slice 256 includes result index 266 that indicates coordinate for values included in slice 256.

In this illustrative example, program instructions manager 220 can use a number of slicing methods from slicing methods 226 to generate the number of slices 234. For example, program instructions manager 220 can slice multi-dimensional table 236 by rows and treat each row in multi-dimensional table 236 as a slice in the number of slices 234. In an alternative example, program instructions manager 220 can slice multi-dimensional table 236 by columns and treat each column in multi-dimensional table 236 as a slice in the number of slices 234. In yet another example, program instructions manager 220 can treat entire multi-dimensional table 236 as a slice in the number of slices 234.

In this illustrative example, program instructions manager 220 can determine induction variable 224 for modified loops 212 based on slicing methods 226. For example, program instructions manager 220 can select the iterator that is represented by rows in multi-dimensional table 236 as induction variable 224 if multi-dimensional table 236 is sliced by rows. In an alternative example, program instructions manager 220 can select the iterator that is represented by columns in multi-dimensional table 236 as induction variable 224 if multi-dimensional table 236 is sliced by columns. In yet another example, program instructions manager 220 can generate induction variable 224 to mimic traversing of multi-dimensional table 236 in a one-dimensional fashion if the entire multi-dimensional table 236 is treated as one slice. In this illustrative example, induction variable 224 is an iterator that iterates through execution of modified loops 212.

Program instructions manager 220 generates a number of sequences 232 by splitting values for each result index and each slice in the number of slices 234. For example, a sequence in the number of sequences 232 can be generated for result index 266 of slice 256. In this illustrative example, the number of sequences 232 contains values 252 and strides 254. Values 252 are values obtained from the number of slices 234, and strides such as strides 254 are step size or spacing between values in each sequence. For example, a sequence of [1,2,3,4] has a stride of 1, a sequence of [5,7,9,11] has a stride of 2, and a sequence of [1,1,1,1] has a stride of 0. In this illustrative example, strides 254 can include zero stride and non-zero stride for the number of sequences 232. In other words, each sequence in the number of sequences has a number of values from values 252 and a fixed stride from strides 254.

In this illustrative example, start values for each sequence in the number of sequences 232 are determined by using the first value of a sequence minus the number of previous elements in the slice prior to each sequence multiplied by the value of stride for the sequence. In addition, program instructions manager 220 can also determine an interval marker for each sequence in the number of sequences 232. In this illustrative example, the interval marker for each sequence is determined by the value of induction variable 224 that corresponds to the last element in each sequence.

In this illustrative example, program instructions manager 220 can adjust sequences 232 such that interval markers of sequences across result indices for each slicing method match. For example, values for result indices 0,1 for sequences 232 can be 4, 7, 10|12, 13 and 1, 3|6, 9, 12 respectively, and induction variable 224 can run from 0 to 4, where “|” are used to visually separate sequences within each slice. In this example, the interval markers are not matched because interval marker of 2 for sequence [4,7,10] is not equal to the interval marker of 1 for sequence [1,3] of result index 0, and the interval markers are not matched because interval marker of 1 for sequence [12,13] is not equal to the interval marker of 2 for sequence [6,9,12] of result index 1.

In this illustrative example, the above mentioned sequence can be adjusted to 4, 7|10|12, 13 and 1, 3|6|9, 12, respectively such that interval markers are now matched between sequences across result indices, where “|” are used to visually separate sequences within each slice.

In an alternative example, program instructions manager 220 can also adjust sequences 232 such that counts of sequences in each slice match across slices for each result index. In yet another example, program instructions manager 220 can determine whether induction variable 224 is the innermost iterators for loops 222. If induction variable 224 is not the innermost iterators for loops 222, program instructions manager 220 can adjust sequences 232 by splitting all sequences with non-zero stride into a number of length 1 sequences with zero stride. By such a method, the use-before-definition problem in modified loops 212 can be eliminated.

In this illustrative example, program instructions manager 220 can generate lists 230 for the number of slices 234 based on sequences 232. Each list in lists 230 includes numerical information from each sequence in the number of sequences 232. For example, each list in lists 230 can include uncommon start values in sequences for each slice in the number of slices 234 from values 252 and uncommon strides for sequences for each slice in the number of slices 234 from strides 254. In addition, each list in lists 230 can also include uncommon interval markers for sequences in the number of sequences 232. In this illustrative example, uncommon start values, uncommon strides, and uncommon interval markers for each sequence from uncommon start values 270, uncommon strides 272, and uncommon interval markers 268 in lists 230, respectively.

In this illustrative example, program instructions manager 220 can generate a number of new induction variables 238 using lists 230. The number of new induction variables 238 are iterators that can be used in modified loops 212. In this illustrative example, sets of corresponding sequences across slices are compared and a new induction variable is generated for each set of corresponding sequences that includes at least one sequence with non-zero stride.

In this illustrative example, the number of new induction variables 238 includes start values 258 determined based on common sequence start values from values 252 and uncommon start values from uncommon start values 270, and strides 260 determined based on common sequence strides from strides 254 and uncommon strides from uncommon strides 272.

In this illustrative example, program instructions manager 220 can generate a number of new conditionals 246 using the number of new induction variables 238, existing variables and iterators from loops 222, lists 230, common strides in strides 254, and common values in values 252 for the number of sequences 232.

In this illustrative example, a first new conditional in number of new conditionals 246 is generated for induction variable 224 for each slicing method. In this example, the first new conditional is generated based on lists 230, common start values from values 252, and common strides from strides 254. In addition, a second new conditional in the number of new conditionals 246 is generated for other induction variables for slicing methods that slice multi-dimensional table 236 by rows and columns. In this illustrative example, the other induction variables can include existing induction variables from loops 222 and new induction variables 238. The second new conditional is generated based on lists 230. In this illustrative example, the second new conditional can use the same variable for lists of different slices in lists 230.

As a result, program instructions manager 220 can generate modified loops 212 for loops 222 using new conditionals 246. In this illustrative example, modified loops 212 can include loops for different slicing methods in slicing methods 226. Program instructions manager 220 can determine costs 218 for modified loops 212 to determine which slicing method can result in loops with the lowest cost. In this illustrative example, costs 218 can be determined through a cost analysis. The cost analysis can be performed in a number of ways, for example, the cost analysis can be performed by generating conditional trees for loops of each slicing method in modified loops 212. In this illustrative example, conditional trees generated for loops of each slicing method in modified loops 212 can be part of conditional trees 228.

Program instructions manager 220 can identify set of modified loops 244 as the loops with the lowest cost. In this illustrative example, set of modified loops 244 includes loops for slicing methods that have the lowest number of leaves based on the conditional trees generated for loops of each slicing method in modified loops 212. It should be understood that set of modified loops 244 may include loops for more than one slicing methods in case of a tie. In this illustrative example, program instructions manager 220 can further identify loops from set of modified loops 244 that has fewest new induction variables from new induction variables 238. In this illustrative example, program instructions manager 220 can further select loops for a slicing method that maintains perfect loop nests as the loops with the lowest cost in case of another tie.

In this illustrative example, program instructions manager 220 can replace loops 222 with set of modified loops 244, loops for a slicing method with the lowest cost based on costs 218.

In this illustrative example, user 206 can interact with computer system 204 through user inputs to computer system 204. For example, computer system 204 can track, monitor, and review the process of generating modified loops 212 for loops 222.

In this illustrative example, user input 208 can be generated by user 206 using human machine interface (HMI) 210. As depicted, human machine interface 210 includes display system 240 and input system 242. Display system 240 is a physical hardware system and includes one or more display devices on which graphical user interface 262 can be displayed. The display devices can include at least one of a light emitting diode (LED) display, an organic light emitting diode (OLED) display, a computer monitor, a projector, a flat panel display, a heads-up display (HUD), a head-mounted display (HMD), smart glasses, augmented reality glasses, or some other suitable device that can output information for the visual presentation of information.

In this example, user 206 is a person that can interact with graphical user interface 262 through user input 208 generated by input system 242. Input system 242 is a physical hardware system and can be selected from at least one of a mouse, a keyboard, a touch pad, a trackball, a touchscreen, a stylus, a motion sensing input device, a gesture detection device, a data glove, a cyber glove a haptic feedback device, or some other suitable type of input device. For example, user 206 can view modified loops 212 and cost analysis of modified loops 212 to determine whether replacing loops 222 with loops in modified loops 212 is appropriate.

In one illustrative example, one or more solutions are present that overcome a problem with optimizing loops in program instructions. As a result, one or more technical solutions may provide an ability to increase the efficiency and performance in computer system 204. For example, a compiler can utilize above mentioned loop optimization techniques during compiling process to enhance performance in computer system 204.

In the illustrative example, computer system 204 can be configured to perform at least one of the steps, operations, or actions described in the different illustrative examples using software, hardware, firmware, or a combination thereof. As a result, computer system 204 operates as a special purpose computer system in which program instructions manager 220 in computer system 204 enables loop optimizations for compilers. In particular, program instructions manager 220 transforms computer system 204 into a special purpose computer system as compared to currently available general computer systems that do not have program instructions manager 220.

In the illustrative example, the use of program instructions manager 220 in computer system 204 integrates processes into a practical application for optimizing loops. In other words, program instructions manager 220 in computer system 204 is directed to a practical application of processes integrated into program instructions manager 220 in computer system 204 that optimizes loops to reduce program instruction size. In this illustrative example, program instructions manager 220 can efficiently help computer system 204 to increase computer performance and resources allocation.

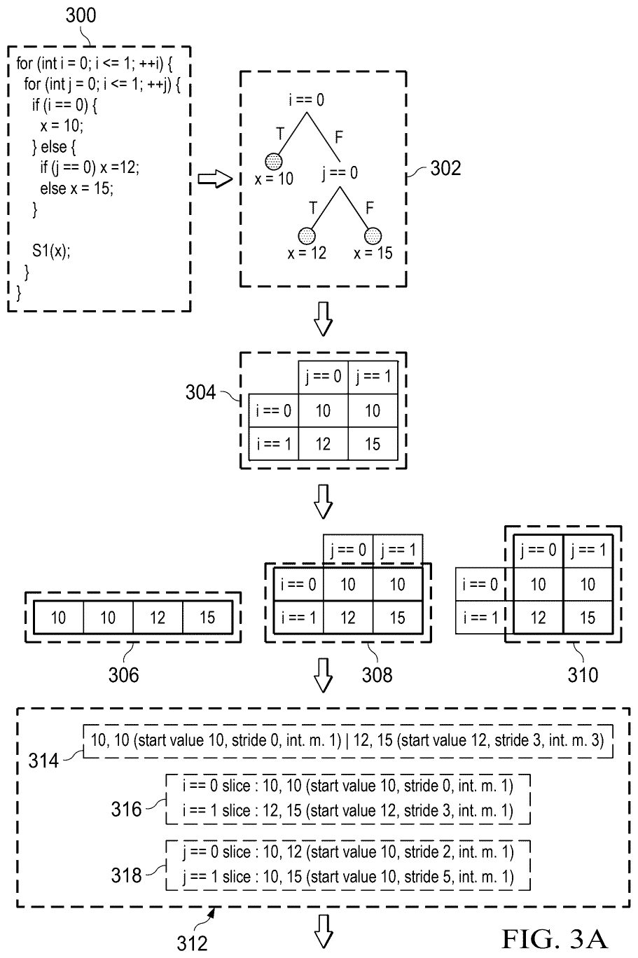

With reference now to FIG. 3A-3B, an illustration of generating modified loops for loops with a number of conditionals is shown in accordance with an illustrative embodiment. In this illustrative example, the process illustrated in FIG. 3A-3B can be implemented in hardware, software, or both. When implemented in software, the process can take the form of program instructions that are run by one of more processor units located in one or more hardware devices in one or more computer systems. For example, the process can be implemented in program instructions manager 220 in computer system 204 in FIG. 2.

In FIG. 3A, program instructions 300 includes loops with a number of conditionals. In this illustrative example, conditional tree 302 can be generated based on program instructions 300. As depicted, conditional tree 302 indicates conditionals and end results of program instructions 300 as program instructions 300 iterates.

Multi-dimensional table 304 is generated based on conditional tree 302. In this illustrative example, values in multi-dimensional table 304 are based on values from conditional tree 302. In other words, values in multi-dimensional table 304 are determined by evaluating conditionals in program instructions 300.

In this illustrative example, each dimension in multi-dimensional table 304 represents an iterator in program instructions 300. For example, the columns in multi-dimensional table 304 represent different values of iterator “j” in program instructions 300 and the rows in multi-dimensional table 304 represents different values of iterator “i” in program instructions 300.

As depicted, multi-dimensional table 304 can be sliced using different slicing methods. In this illustrative example, slice 306 is generated by treating entirety of multi-dimensional table 304 as one slice, slice 308 includes two slices that are generated by slicing multi-dimensional table 304 by rows, and slices 310 include two slices generated by slicing multi-dimensional table 304 by columns.

As depicted, an induction variable is determined for each slicing method. For example, iterator “j” is selected as the induction variable for the slicing method that slices multi-dimensional table 304 by rows and iterator “i” is selected as the induction variable for the slicing method that slices multi-dimensional table 304 by columns. In addition, the induction variable can be generated to mimic traversing of multi-dimensional table 304 in a one-dimensional fashion if the entire multi-dimensional table 304 is treated as one slice.

In this illustrative example, the generation of modified loops using different slicing methods is conducted separately without interfering with each other. In other words, modified loops generated through each slicing method are unique and different from modified loops generated through other slicing methods.

Sequences 312 includes sequences generated from each slicing method. In this illustrative example, each sequence in sequences 312 includes a set of values from multi-dimensional table 304, and start values, strides, and interval markers that correspond to value of the induction variable for the last element in each sequence. In this illustrative example, sequences 314 includes two sequences generated based on slice 306, sequences 316 includes two sequences generated based on slices 308, and sequences 318 includes two sequences generated based on slices 310.

Sequences 312 can further be adjusted to ensure proper execution of modified loops generated based on sequences 312. In this illustrative example, sequences 318 need to adjust by splitting sequences into zero-stride sequences in order to eliminate user-before-definition issues in modified loops generated based on sequences 318.

As depicted in FIG. 3B, sequences 320 illustrates sequences of sequences 318 after adjustment. In this illustrative example, the two sequences in sequences 318 are split into four sequences with zero stride.

In this illustrative example, program instructions 322 are generated for the slicing method that treats entirety of multi-dimensional table 304 as one slice. In this illustrative example, a number of new induction variables are generated for program instructions 322. For example, induction variable “synth_iv” and induction variable “seq” are generated for new conditionals and “synth_iv” is determined as the induction variable that mimics traversing of the multi-dimensional table in a one-dimensional fashion. In this illustrative example, start values and strides for induction variable “synth_iv” are 0 and 1 respectively, and start values and strides for induction variable “seq” are obtained directly from sequences in sequences 314. In this illustrative example, a new conditional is generated for each sequence in sequences 314 based on the new induction variables, start values, strides, and interval markers from each sequence in sequences 314.

In a similar fashion, program instructions 324 are generated for the slicing method that slices multi-dimensional table 304 by rows. In program instructions 324, iterator “j” is selected as the induction variable since iterator “i” is constant for each slice in sequences 316. In this illustrative example, a number of lists that include uncommon start values across different sequences in sequences 316, uncommon strides for sequences from sequences 316, and uncommon interval markers for sequences from sequences 316 are generated. For example, list “enc” can include values (10,0) when “i” equals to 0, which are obtained from start value and stride of sequence for i==0 slice in sequences 316. In another example, list “enc” can include values (12,3) when “i” does not equal to 0, which are obtained from start value and stride of sequence for i==1 slice in sequences 316.

In this illustrative example, a number of new induction variables are generated for program instructions 324. For example, induction variable “seq” is generated for new conditionals. In this illustrative example, start value and stride for induction variable “seq” are determined based on the lists generated. A new conditional is generated with a condition for each sequence in a slice in sequences 316 based on the determined lists and common values, common strides and common interval markers from each sequence in sequences 316. Since each slice in sequences 316 has exactly one sequence, the new conditional can be discarded entirely and value yielded by the discarded condition directly for program instructions 324. In this illustrative example, the new conditionals are generated to mimic iterations of program instructions 300.

Further, program instructions 326 are generated for the slicing method that slices multi-dimensional table 304 by columns. In program instructions 326, iterator “i” is selected as the induction variable since iterator “j” is constant for each slice in sequences 320. In a similar fashion, a number of lists that include uncommon start values across different sequences in sequences 320, uncommon strides for sequences from sequences 320, and uncommon interval markers for sequences from sequences 320 are generated. For example, list “enc” can include value “12” when “j” equals to 0, which are obtained from start value of sequence for j==0 slice in sequences 320. In another example, list “enc” can include values “15” when “j” does not equal to 0, which are obtained from start value of sequence for j==1 slice in sequences 320.

In a similar fashion, a new conditional is generated with a condition for each sequence in a slice in sequences 320 based on the determined lists and common values, common strides and common interval markers from each sequence in sequences 320. As depicted, each slice in sequences 320 has two sequences. In this illustrative example, the new conditionals are generated to mimic iterations of program instructions 300.

In FIG. 3B, a cost analysis can be performed for program instructions 322, program instructions 324, and program instructions 326. In this illustrative example, a conditional tree can be generated for each of program instructions 322, program instructions 324, and program instructions 326 and number of leaves on each conditional tree can be compared. In this illustrative example, the program instruction with lowest number of leaves can be identified as the program instruction with the lowest cost. However, program instructions 322 (table as a slice) and program instructions 324 (each row as a slice) are tied with two leaves, as illustrated in table 328. In this illustrative example, counts of new induction variables in program instructions can be compared to resolve this issue. In this example, program instructions 324 is identified as the program instruction with lowest cost because program instructions 324 only has one new induction variable generated for j-loop, as illustrated in table 328. As a result, program instructions 326 can be used to replace program instructions 300 to enhance performance of computer systems.

In all slicing modes, counts of leaves of the new conditional generated on the induction variable will be the number of sequences per slice per result index. In all slicing modes except the one where the entire table is treated as a slice, a second new conditional is generated for remaining induction variables which yields the lists. In this example, counts of leaves for the second new conditional will be the number of slices, or equivalently the product of all the dimensions in the table except the induction variable. In this illustrative example, a 1-leaf conditional can be simplified by removing the condition altogether. In other words, total counts of leaves for a modified loops for a slicing method equals to counts of slices for the slicing method plus counts of sequences per slice per result index for the slicing method.

The illustration of generating program instructions 322, program instructions 324, and program instructions 326 in FIG. 3 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment. For example, no replacement of program instructions should occur if the cost analysis indicates that program instructions 300 are the program instructions with the lowest cost.

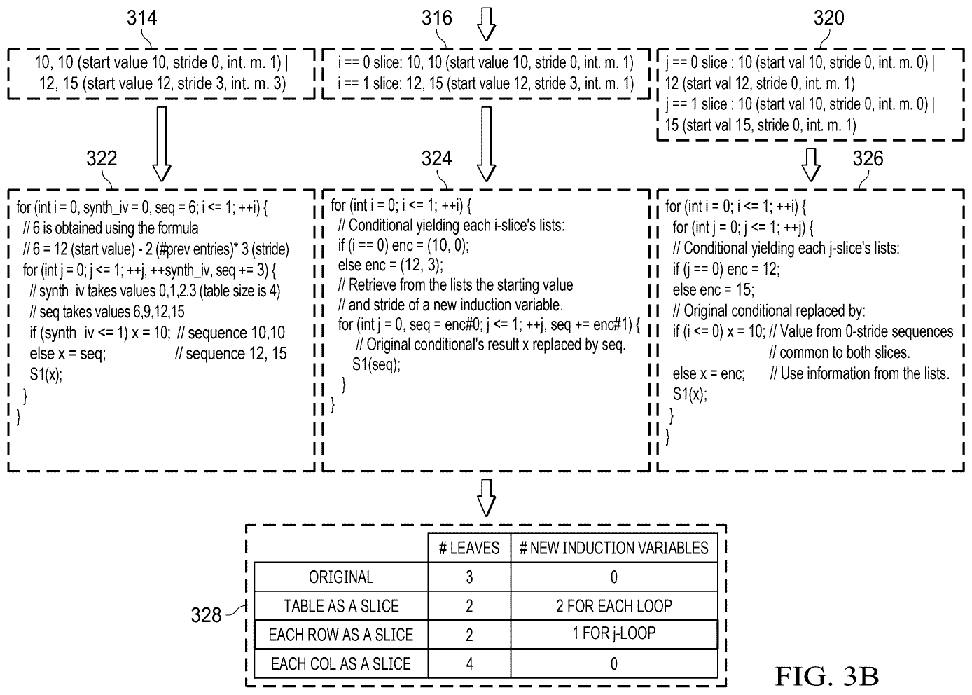

With reference now to FIGS. 4A-4C, an illustration of generating modified loops for loops with a number of conditionals is shown in accordance with an illustrative embodiment. In this illustrative example, the process illustrated in FIGS. 4A-4C can be implemented in hardware, software, or both. When implemented in software, the process can take the form of program instructions that are run by one or more processor units located in one or more hardware devices in one or more computer systems. For example, the process can be implemented in program instructions manager 220 in computer system 204 in FIG. 2.

In FIG. 4A, program instructions 400 includes loops with a number of conditionals. In this illustrative example, conditional tree 402 can be generated based on program instructions 400. As depicted, conditional tree 402 indicates conditionals and end results of program instructions 400 as program instructions 400 iterates. In this illustrative example, conditional tree 402 includes 8 leaves.

Multi-dimensional table 404 is generated based on conditional tree 402. In this illustrative example, values in multi-dimensional table 404 are based on values from conditional tree 402. In other words, values in multi-dimensional table 404 are determined by evaluating conditionals in program instructions 400.

As depicted, each dimension in multi-dimensional table 404 represents an iterator in program instructions 400. For example, the columns in multi-dimensional table 404 represent different values of iterator “j” in program instructions 400 and the rows in multi-dimensional table 404 represent different values of iterator “i” in program instructions 400. In this illustrative example, each entry in multi-dimensional table 404 includes 2 values, which correspond to result indices 0 and 1. For example, entry (1,5) includes value “1” for result index 0, and value “5” for result index 1. In another example, entry (0,11) includes value “0” for result index 0, and value “11” for result index 1.

As depicted, multi-dimensional table 404 can be sliced using different slicing methods to generate slices 406. In this illustrative example, slice 408 is generated by treating entirety of multi-dimensional table 404 as one slice, slices 410 include two slices that are generated by slicing multi-dimensional table 404 by rows, and slices 412 include four slices generated by slicing multi-dimensional table 404 by columns.

As depicted, an induction variable is determined for each slicing method. For example, iterator “j” is selected as the induction variable for the slicing method that slices multi-dimensional table 404 by rows and iterator “i” is selected as the induction variable for the slicing method that slices multi-dimensional table 404 by columns. In addition, the induction variable can be generated to mimic traversing of multi-dimensional table 404 in a one-dimensional fashion if entire multi-dimensional table 404 is treated as one slice.

In a similar fashion, the generation of modified loops using different slicing methods shown in FIG. 4 is conducted separately without interfering with each other. In other words, modified loops generated through each slicing method are unique and different from modified loops generated through other slicing methods.

As depicted in FIG. 4B, sequences 414 includes sequences generated from each slicing method. In this illustrative example, each sequence in sequences 414 includes a set of values based on values from multi-dimensional table 404, and start values, strides, and interval markers that correspond to value of the induction variable for the last element in each sequence. In this illustrative example, the sequence notation for sequences in sequences 414 is (sequence start value - number of previous elements in slice prior to the sequence*stride, stride, interval marker).

In this illustrative example, sequences 416 includes seven sequences generated based on slice 408, sequences 418 includes seven sequences generated based on slices 410, and sequences 420 includes eight sequences generated based on slices 412.

In this illustrative example, adjusted sequences 422 are generated by adjusting sequences 414 to ensure proper execution of modified loops generated based on sequences 414. In this illustrative example, sequences 416 are adjusted such that the interval marker in each sequence is matched across result indices, as shown in sequence 424. In a similar fashion, sequences 418 are adjusted such that interval marker in each sequence is matched across result indices, as shown in sequence 426.

In addition, sequences 420 are adjusted because the induction variable “i” for slicing method of slices 412 is not the innermost iterator for program instructions 400. In this illustrative example, sequences 428 are generated by splitting sequences in sequences 420 into length 1 zero stride sequences. As depicted, the adjustment performed for sequences 420 eliminates the definition-before-use issues in modified loops generated based on sequences 420.

In this illustrative example, program instructions 430 are generated for the slicing method that treats entirety of multi-dimensional table 404 as one slice. In this illustrative example, a number of new induction variables are generated for program instructions 430. For example, induction variable “synth_iv” and “seq” are generated for new conditionals and “synth_iv” is determined as the induction variable that mimics traversing of the multi-dimensional table in a one-dimensional fashion. In this illustrative example, start values and strides for induction variable “synth_iv” are 0 and 1 respectively, and start values and strides for induction variable “seq” are obtained directly from sequences in sequences 424. In this illustrative example, new conditionals are generated based on the new induction variables, start values, strides, and interval markers from each sequence in sequences 424. In this illustrative example, the new conditionals in program instructions 430 are generated to mimic iterations of program instructions 400.

In a similar fashion, program instructions 432 are generated for the slicing method that slices multi-dimensional table 404 by rows. In program instructions 432, iterator “j” is selected as the induction variable since iterator “i” is constant for each slice in sequences 426. In this illustrative example, a number of lists are generated to include uncommon values between different sequences of same result index across slices, uncommon strides between different sequences of same result index across slices, and uncommon interval markers between different sequences of same result index across slices.

For example, list “enc” can include values (1, 0, 5, 21, 2, 5, 2) when “i” equals to 0, which are obtained from uncommon values, uncommon strides, and uncommon interval markers of sequence for i==0 slice in sequences 426. In another example, list “enc” can include values (4, 2, 4, 22, 0, 11, 0) when “i” equals to 1, which are obtained from uncommon values, uncommon strides, and uncommon interval markers of sequence for i==1 slice in sequences 426. In this illustrative example, only one uncommon interval marker is included in the list per sequence irrespective of result index because the interval markers are matched across result indices.

In this illustrative example, a number of new induction variables are generated for program instructions 432. For example, induction variable “seq0_idx0”, induction variable “seq0_idx1”, and induction variable “seq1_idx1” are generated for new conditionals. In this illustrative example, start value and stride induction variable “seq0_idx0” are determined based on the lists generated. In this illustrative example, a number of new conditionals are generated based on the new induction variables, existing variables from program instructions 400, values from lists generated for program instructions 432, and common values in sequence 426. In this illustrative example, the new conditionals in program instructions 432 are generated to mimic iterations of program instructions 400.

Further, program instructions 434 are generated for the slicing method that slices multi-dimensional table 404 by columns. In program instructions 434, iterator “i” is selected as the induction variable since iterator “j” is constant for each slice in sequences 428. In a similar fashion, a number of lists are generated to include uncommon values between different sequences of same result index across slices, uncommon strides between different sequences of same result index across slices, and uncommon interval markers between different sequences of same result index across slices.

For example, list “enc” can include values (1, 5, 4, 4) when “j” equals to 20, which are obtained from values, stride, and interval markers of sequence for j==20 slice in sequences 428. In another example, list “enc” can include values (1, 7, 6, 6) when “j” equals 21, which are obtained from uncommon values, uncommon strides, and uncommon interval markers of sequence for j==21 slice in sequences 428. In yet another example, list “enc” can include values (2, 9, 8, 8) when “j” equals 22, which are obtained from uncommon values, uncommon strides, and uncommon interval markers of sequence for j==22 slice in sequences 428. In yet another example, list “enc” can include values (2, 11, 0, 11) when “j” equals 23, which are obtained from uncommon values, uncommon strides, and uncommon interval markers of sequence for j==23 slice in sequences 428.

In this illustrative example, no new induction variables are generated for program instructions 434 because all sequences have zero strides. In this illustrative example, a number of new conditionals are generated based on existing variables from program instructions 400, values from lists generated for program instructions 434, and common values in sequence 428. In this illustrative example, the new conditionals in program instructions 432 are generated to mimic iterations of program instructions 400.

In FIG. 4C, a cost analysis can be performed for program instructions 430, program instructions 432, and program instructions 434. In this illustrative example, a conditional tree can be generated for each of program instructions 430, program instructions 432, and program instructions 434 and number of leaves on each conditional tree can be compared. In this illustrative example, the program instruction with the lowest number of leaves can be identified as the program instruction with the lowest cost. However, program instructions 430 (table as a slice) and program instructions 432 (each row as a slice) are tied with four leaves, as illustrated in table 436. In this illustrative example, counts of new induction variables in program instructions can be compared to resolve this issue. In this example, program instructions 432 is identified as the program instruction with lowest cost because program instructions 432 only has three new induction variable is generated for j-loop, as illustrated in table 436. As a result, program instructions 432 can be used to replace program instructions 400 to enhance the performance of computer systems.

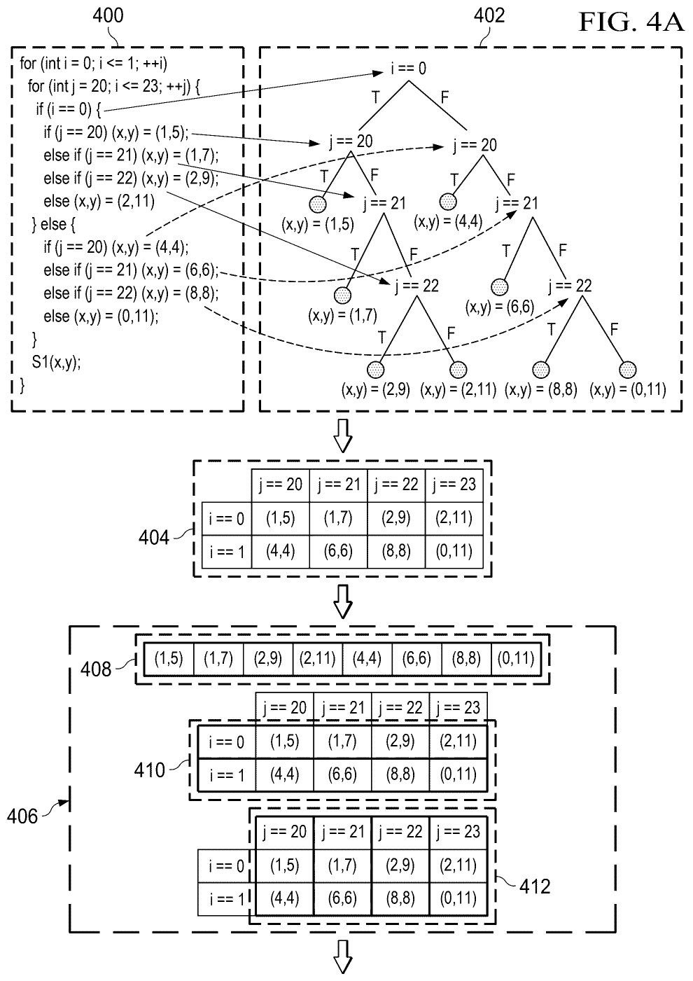

With reference now to FIG. 5, a flowchart illustrating a process for generating modified loops for loops with a number of conditionals is shown in accordance with an illustrative embodiment. The process in FIG. 5 can be implemented in hardware, software, or both. When implemented in software, the process can take the form of program instructions that are run by one of more processor units located in one or more hardware devices in one or more computer systems. For example, the process can be implemented in program instructions manager 220 in computer system 204 in FIG. 2.

The process begins by generating a conditional tree based on the number of conditionals in the loops (step 500). In step 500, a value is determined by evaluating each conditional in the number of conditionals. The process generates a multi-dimensional table based on the values for the number of conditionals obtained from the conditional tree (step 502). The process determines an induction variable for the modified loops (step 504). The process slices the multi-dimensional table to generate a number of slices (step 506). In step 506, each slice in the number of slices represents at least a portion of the multi-dimensional table.

The process generates a number of sequences by splitting values in each slice (step 508). In this step, values and strides in the number of sequences are determined for proper execution of the modified loops. The process generates a number of new conditionals based on the determined induction variable and at least values and strides in the number of sequences (step 510). The process generates the modified loops based on the number of new conditionals (step 512). The process terminates thereafter.

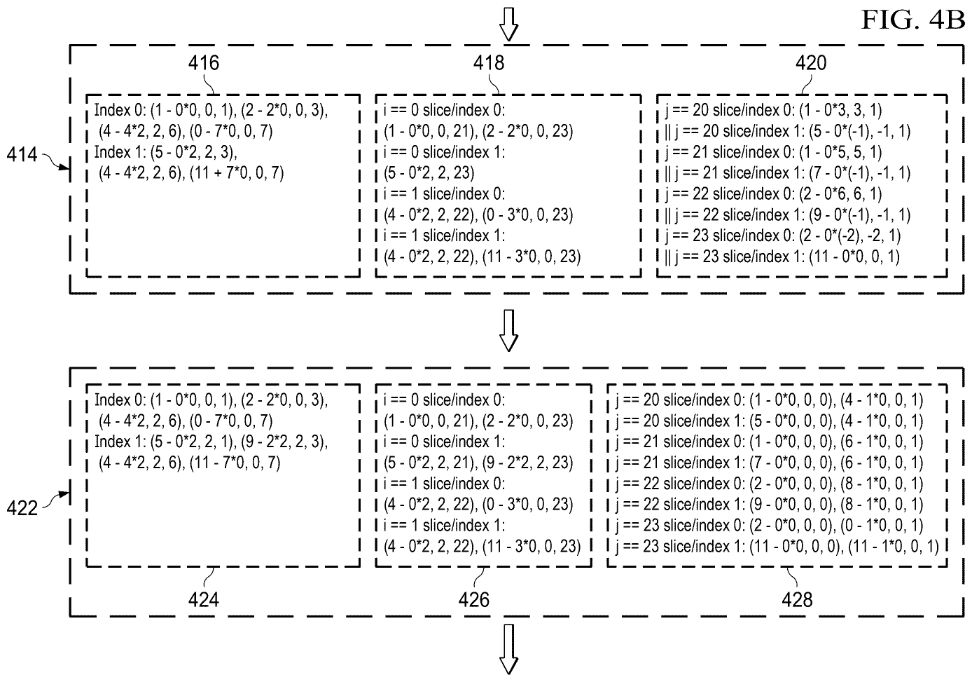

With reference now to FIG. 6, a flowchart illustrating a process for generating sequences by splitting values in each slice is shown in accordance with an illustrative embodiment. The process in this flowchart is an example of an implementation for step 508 in FIG. 5.

The process begins by generating sequences with fixed stride by splitting values in each slice (step 600). As depicted, strides are steps or intervals between values in the sequences. In this step, each sequence in the sequences with fixed stride corresponds to a number of values for a result index in each slice. The process terminates thereafter.

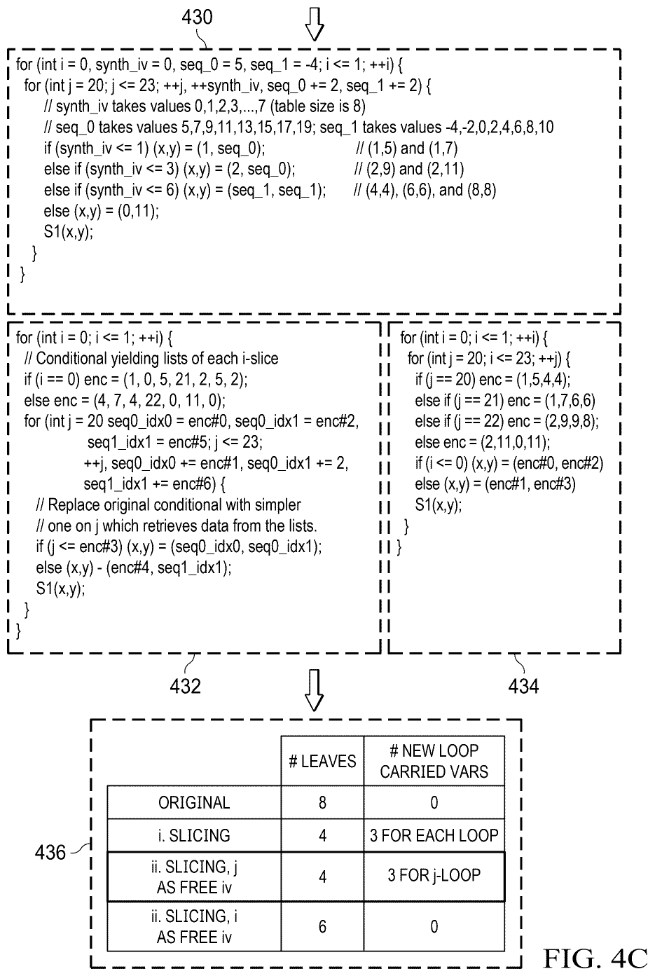

With reference now to FIG. 7, a flowchart illustrating a process for adjusting sequences is shown in accordance with an illustrative embodiment. The process in this figure is an example of an additional step that can be performed with the steps in FIG. 6.

The process begins by determining whether the determined induction variable is innermost iterator for the loops with the number of conditionals based on the conditional tree (step 700). In response to determining that the determined induction variable is not innermost iterator for the loop with the number of conditionals based on the conditional tree, the process adjusts sequences with nonzero stride in the sequences with fixed stride to generate the number of sequences (step 702). In this step, the value for the strides of each sequence in the number of sequences is zero. The process terminates thereafter.

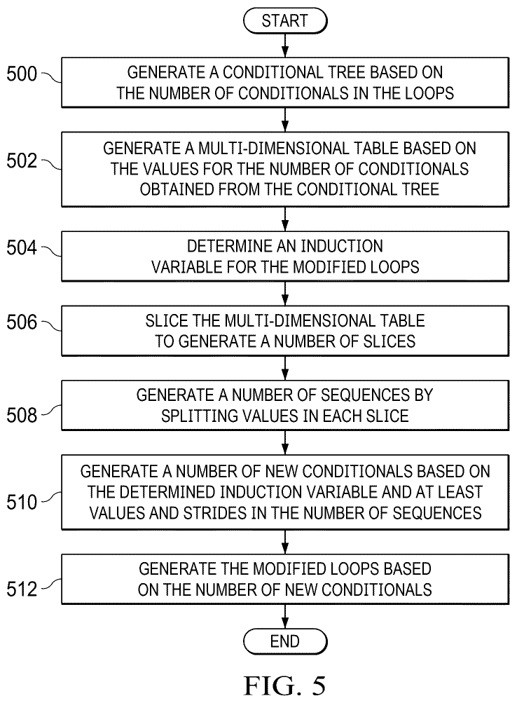

With reference now to FIG. 8, a flowchart illustrating a process for adjusting sequences is shown in accordance with an illustrative embodiment. The process in this figure is an example of an additional step that can be performed with the steps in FIG. 7.

The process begins by generating the number of sequences by splitting sequences with nonzero stride in the sequences with fixed stride (step 800). In this step, the number of sequences for each result index is the same across different slices. The process terminates thereafter.

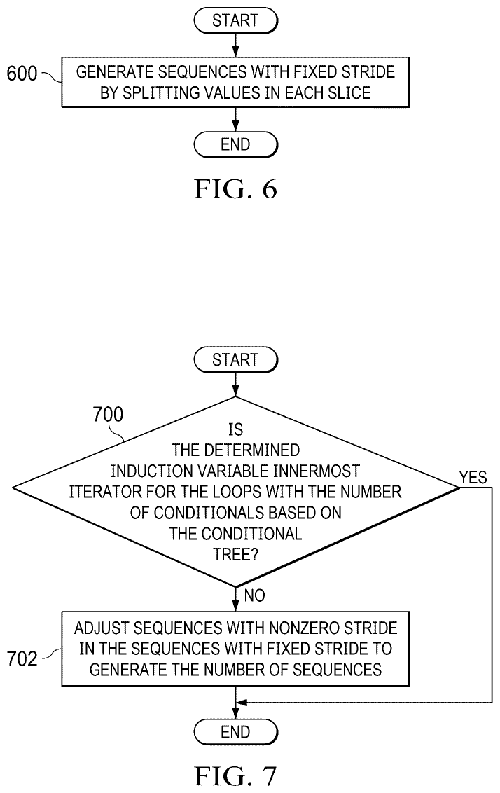

With reference now to FIG. 9, a flowchart illustrating a process for determining the induction variable is shown in accordance with an illustrative embodiment. The process in this flowchart is an example of an implementation for step 504 in FIG. 5.

The process begins by generating the induction variable to mimic traversing of the multi-dimensional table in a one-dimensional fashion (step 900). The process terminates thereafter.

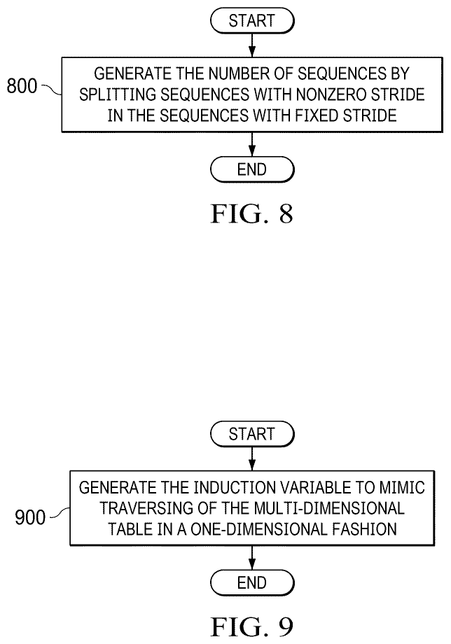

With reference now to FIG. 10, a flowchart illustrating a process for generating the number of new conditionals is shown in accordance with an illustrative embodiment. The process in this figure is an example of an additional step that can be performed with the steps in FIG. 5.

The process begins by generating a number of lists for each slice in the number of slices based on uncommon values and strides in the number of sequences, and values of the determined induction variables corresponding to last terms for sequences of each slice (step 1000). The process generates a number of new induction variables for the modified loops (step 1002). In step 1002, start values and strides for the number of new induction variables are determined based on values from the number of lists. The process generates the number of new conditionals using the number of new induction variables, existing variables from the loops, values from the number of lists, and common values in the number of sequences (step 1004). The process terminates thereafter.

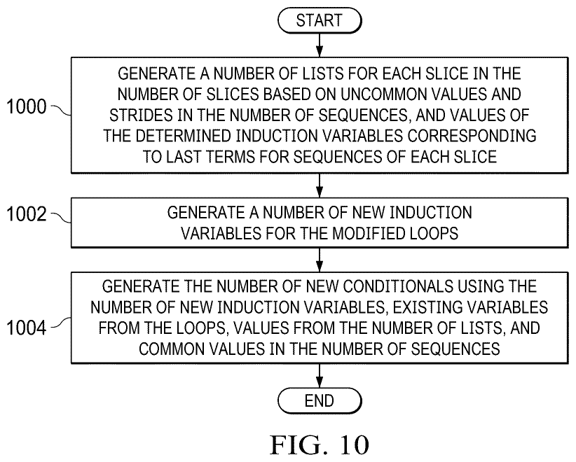

With reference now to FIG. 11, a flowchart illustrating a process for generating modified loops for loops with a number of conditionals is shown in accordance with an illustrative embodiment. The process in FIG. 11 can be implemented in hardware, software, or both. When implemented in software, the process can take the form of program instructions that are run by one or more processor units located in one or more hardware devices in one or more computer systems. For example, the process can be implemented in program instructions manager 220 in computer system 204 in FIG. 2.

The process begins by generating a conditional tree based on the number of conditionals in the loops (step 1100). The process generates a multi-dimensional table based on values from the number of conditionals (step 1102). The process slices the multi-dimensional table to generate a number of slices using a number of slicing methods (step 1104). In step 1104, each slice in the number of slices represents at least a portion of the multi-dimensional table.

The process generates a number of sequences by splitting values in each slice for each slicing method (step 1106). In this step, values and strides in the number of sequences are determined for proper execution of the modified loops. The process generates a number of new conditionals based on the determined induction variable and at least values and strides in the number of sequences for each slicing method (step 1108). The process generates the modified loops based on the number of new conditionals for each slicing method (step 1110). The process terminates thereafter.

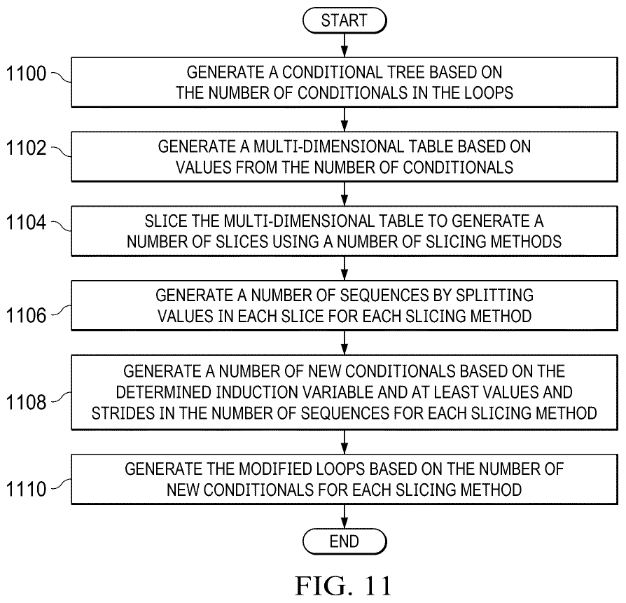

With reference now to FIG. 12, a flowchart illustrating a process for generating new conditionals for the modified loop is shown in accordance with an illustrative embodiment. The process in this flowchart is an example of an implementation for step 1108 in FIG. 11.

The process begins by generating a number of lists for each slicing method based on uncommon values in the number of sequences for each slicing method (step 1200). The process generates a number of new induction variables for the modified loops of each slicing method (step 1202). In this step, start values and strides for the number of new induction variables are determined based on values from the number of lists for each slicing method. The process generates the number of new conditionals for each slicing method using the number of new induction variables for the modified loops of each slicing method, variables from the loops, and common values in the number of sequences for each slicing method (step 1204). The process terminates thereafter.

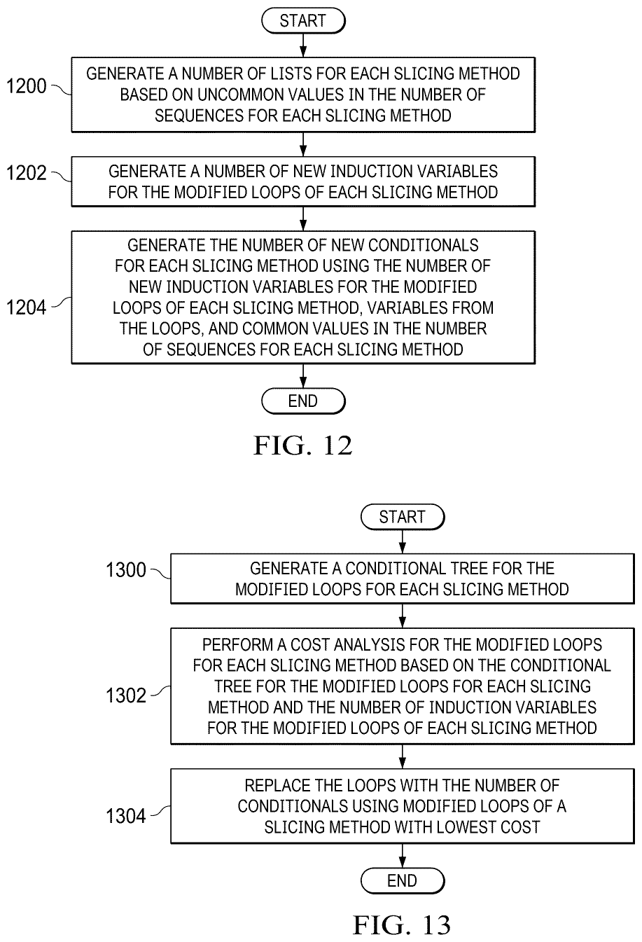

With reference now to FIG. 13, a flowchart illustrating a process for replacing loops with modified loops of the lowest cost is shown in accordance with an illustrative embodiment. The process in this figure is an example of an additional step that can be performed with the steps in FIG. 12.

The process begins by generating a conditional tree for the modified loops for each slicing method (step 1300). The process performs a cost analysis for the modified loops for each slicing method based on the conditional tree for the modified loops for each slicing method and the number of induction variables for the modified loops of each slicing method (step 1302). The process replaces the loops with the number of conditionals using modified loops of a slicing method with lowest cost (step 1304). The process terminates thereafter.

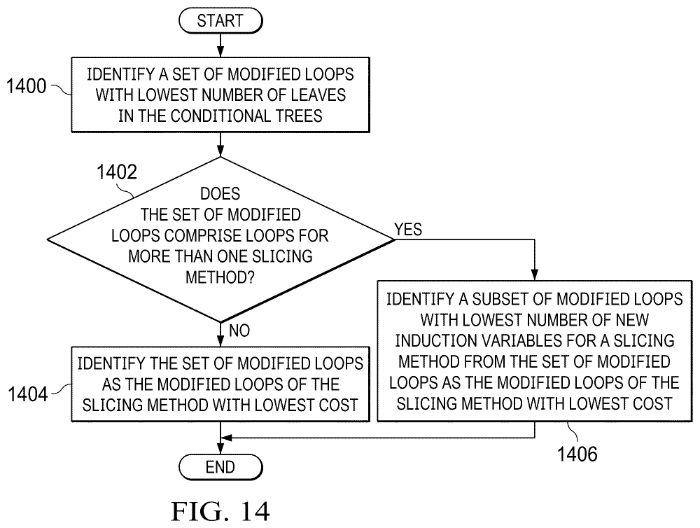

With reference now to FIG. 14, a flowchart illustrating a process for performing cost analysis is shown in accordance with an illustrative embodiment. The process in this flowchart is an example of an implementation for step 1302 in FIG. 13.

The process begins by identifying a set of modified loops with lowest number of leaves in the conditional trees (step 1400). The process determines whether the set of modified loops comprise loops for more than one slicing method (step 1402). The process identifies the set of modified loops as the modified loops of the slicing method with lowest cost in response to determining that the set of modified loops does not comprise loops for more than one slicing method (step 1404). The process terminates thereafter.

With reference again to step 1402, the process identifies a subset of modified loops with lowest number of new induction variables for a slicing method from the set of modified loops as the modified loops of the slicing method with lowest cost in response to determining that the set of modified loops does comprise loops for more than one slicing method (step 1406). The process terminates thereafter.

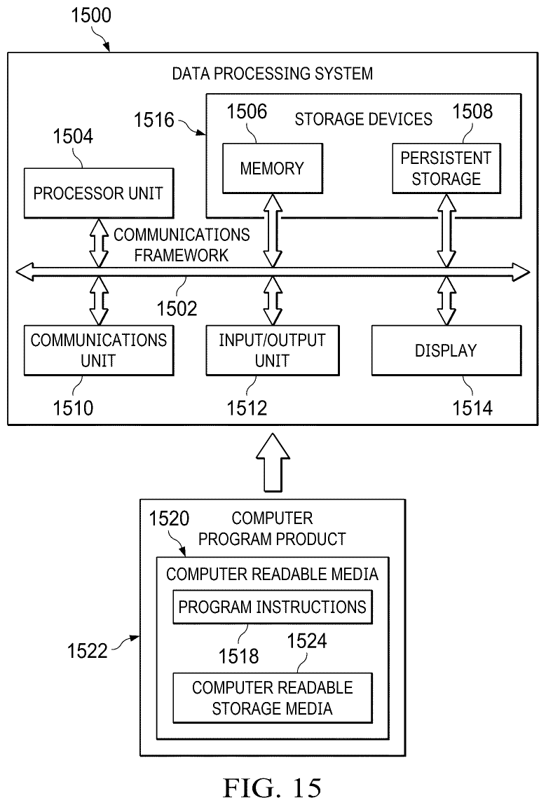

Turning now to FIG. 15, a block diagram of a data processing system is depicted in accordance with an illustrative embodiment. Data processing system 1500 can be used to implement computers and computing devices in computing environment 100 in FIG. 1. Data processing system 1500 can also be used to implement computer system 204 in FIG. 2. In this illustrative example, data processing system 1500 includes communications framework 1502, which provides communications between processor unit 1504, memory 1506, persistent storage 1508, communications unit 1510, input/output (I/O) unit 1512, and display 1514. In this example, communications framework 1502 takes the form of a bus system.

Processor unit 1504 serves to execute instructions for software that can be loaded into memory 1506. Processor unit 1504 includes one or more processors. For example, processor unit 1504 can be selected from at least one of a multicore processor, a central processing unit (CPU), a graphics processing unit (GPU), a physics processing unit (PPU), a digital signal processor (DSP), a network processor, or some other suitable type of processor. Further, processor unit 1504 can be implemented using one or more heterogeneous processor systems in which a main processor is present with secondary processors on a single chip. As another illustrative example, processor unit 1504 can be a symmetric multi-processor system containing multiple processors of the same type on a single chip.

Memory 1506 and persistent storage 1508 are examples of storage devices 1516. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 1516 may also be referred to as computer-readable storage devices in these illustrative examples. Memory 1506, in these examples, can be, for example, a random-access memory or any other suitable volatile or non-volatile storage device. Persistent storage 1508 may take various forms, depending on the particular implementation.

For example, persistent storage 1508 may contain one or more components or devices. For example, persistent storage 1508 can be a hard drive, a solid-state drive (SSD), a flash memory, a rewritable optical disk, a rewritable magnetic tape, or some combination of the above. The media used by persistent storage 1508 also can be removable. For example, a removable hard drive can be used for persistent storage 1508.

Communications unit 1510, in these illustrative examples, provides for communications with other data processing systems or devices. In these illustrative examples, communications unit 1510 is a network interface card.

Input/output unit 1512 allows for input and output of data with other devices that can be connected to data processing system 1500. For example, input/output unit 1512 may provide a connection for user input through at least one of a keyboard, a mouse, or some other suitable input device. Further, input/output unit 1512 may send output to a printer. Display 1514 provides a mechanism to display information to a user.

Instructions for at least one of the operating system, applications, or programs can be located in storage devices 1516, which are in communication with processor unit 1504 through communications framework 1502. The processes of the different embodiments can be performed by processor unit 1504 using computer-implemented instructions, which may be located in a memory, such as memory 1506.

These instructions are referred to as program instructions, computer usable program instructions, or computer-readable program instructions that can be read and executed by a processor in processor unit 1504. The program instructions in the different embodiments can be embodied on different physical or computer-readable storage media, such as memory 1506 or persistent storage 1508.

Program instructions 1518 are located in a functional form on computer readable media 1520 that is selectively removable and can be loaded onto or transferred to data processing system 1500 for execution by processor unit 1504. Program instructions 1518 and computer readable media 1520 form computer program product 1522 in these illustrative examples. In the illustrative example, computer readable media 1520 is computer readable storage media 1524.

Computer readable storage media 1524 is a physical or tangible storage device used to store program instructions 1518 rather than a medium that propagates or transmits program instructions 1518. Computer readable storage media 1524, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program instructions 1518 can be transferred to data processing system 1500 using a computer readable signal media. The computer readable signal media are signals and can be, for example, a propagated data signal containing program instructions 1518. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer readable media 1520” can be singular or plural. For example, program instructions 1518 can be located in computer readable media 1520 in the form of a single storage device or system. In another example, program instructions 1518 can be located in computer readable media 1520 that is distributed in multiple data processing systems. In other words, some instructions in program instructions 1518 can be located in one data processing system while other instructions in program instructions 1518 can be located in one data processing system.

For example, a portion of program instructions 1518 can be located in computer readable media 1520 in a server computer while another portion of program instructions 1518 can be located in computer readable media 1520 located in a set of client computers.

The different components illustrated for data processing system 1500 are not meant to provide architectural limitations to the manner in which different embodiments can be implemented. In some illustrative examples, one or more of the components may be incorporated in or otherwise form a portion of another component. For example, memory 1506, or portions thereof, may be incorporated in processor unit 1504 in some illustrative examples. The different illustrative embodiments can be implemented in a data processing system including components in addition to or in place of those illustrated for data processing system 1500. Other components shown in FIG. 15 can be varied from the illustrative examples shown. The different embodiments can be implemented using any hardware device or system capable of running program instructions 1518.

Thus, illustrative embodiments of the present disclosure provide a computer-implemented method, computer system, and computer program product for managing containers. The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A computer implemented method for generating modified loops for loops with a number of conditionals, the computer implemented method comprising:
generating, by a processor set, a conditional tree based on the number of conditionals in the loops, wherein a value is determined by evaluating each conditional in the number of conditionals;
generating, by the processor set, a multi-dimensional table based on the values for the number of conditionals obtained from the conditional tree;
determining, by the processor set, an induction variable for the modified loops;
slicing, by the processor set, the multi-dimensional table to generate a number of slices, wherein each slice in the number of slices represents at least a portion of the multi-dimensional table;
generating, by the processor set, a number of sequences by splitting values in each slice, wherein values and strides in the number of sequences are determined for proper execution of the modified loops;
generating, by the processor set, a number of new conditionals based on the determined induction variable and at least values and strides in the number of sequences; and
generating, by the processor set, the modified loops based on the number of new conditionals.

2. The computer implemented method of claim 1, wherein each slice from the number of slices comprises a set of values obtained by varying the determined induction variable while fixing other existing induction variables in the loops with the number of conditionals.

3. The computer implemented method of claim 1, wherein the generating, by the processor set, a number of sequences by splitting values in each slice comprises:
generating, by the processor set, sequences with fixed stride by splitting values in each slice, wherein each sequence in the sequences with fixed stride corresponds to a number of values for a result index in each slice.

4. The computer implemented method of claim 3, further comprising:
determining, by the processor set, whether the determined induction variable is innermost iterator for the loops with the number of conditionals based on the conditional tree; and
in response to determining that the determined induction variable is not innermost iterator for the loop with the number of conditionals based on the conditional tree, adjusting, by the processor set, sequences with nonzero stride in the sequences with fixed stride to generate the number of sequences, wherein value for the strides of each sequence in the number of sequences is zero.

5. The computer implemented method of claim 3, further comprising:
generating, by the processor set, the number of sequences by splitting sequences with nonzero stride in the sequences with fixed stride, wherein number of sequences for each result index is same across different slices.

6. The computer implemented method of claim 1, wherein the determining, by the processor set, an induction variable for the modified loops comprises:
generating, by the processor set, the induction variable to mimic traversing of the multi-dimensional table in a one-dimensional fashion.

7. The computer implemented method of claim 1, wherein the number of new conditionals based on the determined induction variable and at least values and strides in the number of sequences comprises:
generating, by the processor set, a number of lists for each slice in the number of slices based on uncommon values and strides in the number of sequences, and values of the determined induction variable corresponding to last terms for sequences of each slice;
generating, by the processor set, a number of new induction variables for the modified loops, wherein start values and strides for the number of new induction variables are determined based on values from the number of lists; and
generating, by the processor set, the number of new conditionals using the number of new induction variables, existing variables from the loops, values from the number of lists, and common values in the number of sequences.

8. A computer system for generating modified loops for loops with a number of conditionals, comprising:
a processor set;
a set of one or more computer-readable storage media; and
program instructions stored on the set of one or more storage media to cause the processor set to perform operations comprising:
generating a conditional tree based on the number of conditionals in the loops, wherein a value is determined by evaluating each conditional in the number of conditionals;
generating a multi-dimensional table based on the values for the number of conditionals obtained from the conditional tree;
determining an induction variable for the modified loops;
slicing the multi-dimensional table to generate a number of slices, wherein each slice in the number of slices represents at least a portion of the multi-dimensional table;
generating a number of sequences by splitting values in each slice, wherein values and strides in the number of sequences are determined for proper execution of the modified loops;
generating a number of new conditionals based on the determined induction variable and at least values and strides in the number of sequences; and
generating the modified loops based on the number of new conditionals.

9. The computer system of claim 8, wherein each slice from the number of slices comprises a set of values obtained by varying the determined induction variable while fixing other existing induction variables in the loops with the number of conditionals.

10. The computer system of claim 9, wherein the generating a number of sequences by splitting values in each slice comprises:
generating sequences with fixed stride by splitting values in each slice, wherein each sequence in the sequences with fixed stride corresponds to a number of values for a result index in each slice.

11. The computer system of claim 10, wherein the operations further comprise:
determining whether the determined induction variable is innermost iterator for the loops with the number of conditionals based on the conditional tree; and
in response to determining that the determined induction variable is not innermost iterator for the loop with the number of conditionals based on the conditional tree, adjusting sequences with nonzero stride in the sequences with fixed stride to generate the number of sequences, wherein value for the strides of each sequence in the number of sequences is zero.

12. The computer system of claim 10, wherein the operations further comprise:
generating the number of sequences by splitting sequences with nonzero stride in the sequences with fixed stride, wherein number of sequences for each result index is same across different slices.

13. The computer system of claim 10, wherein the determining an induction variable for the modified loop comprises:
generating the induction variable to mimic traversing of the multi-dimensional table in a one-dimensional fashion.

14. The computer system of claim 8, wherein the generating the number of new conditionals based on the determined induction variable and at least values and strides in the number of sequences comprises:
generating a number of lists for each slice in the number of slices based on uncommon values and strides in the number of sequences, and values of the determined induction variable corresponding to last terms for sequences of each slice;
generating a number of new induction variables for the modified loops, wherein start values and strides for the number of new induction variables are determined based on values from the number of lists; and
generating the number of new conditionals using the number of new induction variables, existing variables from the loops, values from the number of lists, and common values in the number of sequences.

15. A computer program product for generating modified loops for loops with a number of conditionals, comprising:
a set of one or more computer-readable storage media;
program instructions stored in the set of one or more storage media to perform operations comprising:
generating, by a processor set, a conditional tree based on the number of conditionals in the loops, wherein a value is determined by evaluating each conditional in the number of conditionals;
generating, by the processor set, a multi-dimensional table based on values for the number of conditionals obtained from the conditional tree;
determining, by the processor set, an induction variable for the modified loops;
slicing, by the processor set, the multi-dimensional table to generate a number of slices, wherein each slice in the number of slices represent at least a portion of the multi-dimensional table;
generating, by the processor set, a number of sequences by splitting values in each slice, wherein values and strides in the number of sequences are determined for proper execution of the modified loops;
generating, by the processor set, a number of new conditionals based on the determined induction variable and at least values and strides in the number of sequences; and
generating, by the processor set, the modified loops based on the number of new conditionals.

16. The computer program product of claim 15, wherein each slice from the number of slices comprises a set of values obtained by varying the determined induction variable while fixing other existing induction variables in the loops with the number of conditionals.

17. The computer program product of claim 16, wherein the generating a number of sequences by splitting values in each slice comprises:
generating, by the processor set, sequences with fixed stride by splitting values in each slice, wherein each sequence in the sequences with fixed stride corresponds to a number of values for a result index in each slice.

18. The computer program product of claim 17, wherein the operations further comprise:
determining, by the processor set, whether the determined induction variable is innermost iterator for the loops with the number of conditionals based on the conditional tree; and
in response to determining that the determined induction variable is not innermost iterator for the loop with the number of conditionals based on the conditional tree, adjusting, by the processor set, sequences with nonzero stride in the sequences with fixed stride to generate the number of sequences, wherein value for the strides of each sequence in the number of sequences is zero.

19. The computer program product of claim 17, wherein the operations further comprise:
generating, by the processor set, the number of sequences by splitting sequences with nonzero stride in the sequences with fixed stride, wherein number of sequences for each result index is same across different slices.

20. The computer program product of claim 15, wherein the generating, by the processor set, the number of new conditionals based on the determined induction variable and at least values and strides in the number of sequences comprises:
generating, by the processor set, a number of lists for each slice in the number of slices based on uncommon values and strides in the number of sequences, and values of the determined induction variable corresponding to last terms for sequences of each slice;
generating, by the processor set, a number of new induction variables for the modified loops, wherein start values and strides for the number of new induction variables are determined based on values from the number of lists; and
generating, by the processor set, the number of new conditionals using the number of new induction variables, existing variables from the loops, values from the number of lists, and common values in the number of sequences.

21. A computer implemented method for generating modified loops for loops with a number of conditionals, the computer implemented method comprising:
generating, by a processor set, a conditional tree based on the number of conditionals in the loops, wherein a value is determined by evaluating each conditional in the number of conditionals;
generating, by the processor set, a multi-dimensional table based on the values for the number of conditionals obtained from the conditional tree;
slicing, by the processor set, the multi-dimensional table to generate a number of slices using a number of slicing methods, wherein each slice in the number of slices represent at least a portion of the multi-dimensional table;
generating, by the processor set, a number of sequences by splitting values in each slice for each slicing method, wherein values and strides in the number of sequences are determined for proper execution of the modified loops;
generating, by the processor set, a number of new conditionals based on at least values and strides in the number of sequences for each slicing method; and
generating, by the processor set, the modified loops based on the number of new conditionals for each slicing method.

22. The computer implemented method of claim 21, wherein the generating, by the processor set, the number of new conditionals based on at least values and strides in the number of sequences for each slicing method comprises:
generating, by the processor set, a number of lists for each slicing method based on uncommon values in the number of sequences for each slicing method;
generating, by the processor set, a number of new induction variables for the modified loops of each slicing method, wherein start values and strides for the number of new induction variables are determined based on values from the number of lists for each slicing method; and
generating, by the processor set, the number of new conditionals for each slicing method using the number of new induction variables for the modified loops of each slicing method, existing variables from the loops, values from the number of lists, and common values in the number of sequences for each slicing method.

23. The computer implemented method of claim 22, further comprising:
generating, by the processor set, a conditional tree for the modified loops for each slicing method;
performing, by the processor set, a cost analysis for the modified loops for each slicing method based on the conditional tree for the modified loops for each slicing method and the number of new induction variables for the modified loops of each slicing method; and
replacing, by the processor set, the loops with the number of conditionals using modified loops of a slicing method with lowest cost.

24. The computer implemented method of claim 23, wherein the performing, by the processor set, the cost analysis for the modified loops for each slicing method based on the conditional tree for the modified loops for each slicing method and the number of new variables for the modified loops of each slicing method comprises:
identifying, by the processor set, a set of modified loops with lowest number of leaves in the conditional trees;
determining, by the processor set, whether the set of modified loops comprise loops for more than one slicing method; and
in response to determining that the set of modified loops does not comprise loops for more than one slicing method, identifying, by the processor set, the set of modified loops as the modified loops of the slicing method with lowest cost.

25. The computer implemented method of claim 24, further comprising:
in response to determining that the set of modified loops does comprise loops for more than one slicing method, identifying, by the processor set, a subset of modified loops with lowest number of new induction variables for a slicing method from the set of modified loops as the modified loops of the slicing method with lowest cost.
